(19) United States
(12) Patent Application Publication
(10) Pub. No.: US 2020/0050894 A1
(43) Pub. Date: Feb. 13, 2020

(54) ARTIFICIAL INTELLIGENCE APPARATUS AND METHOD FOR PROVIDING LOCATION INFORMATION OF VEHICLE

(71) Applicant: LG ELECTRONICS INC., Seoul (KR)

(72) Inventor: Kyungsoon PARK, Seoul (KR)

(73) Assignee: LG ELECTRONICS INC., Seoul (KR)

(21) Appl. No.: 16/657,330

(22) Filed: Oct. 18, 2019

(30) Foreign Application Priority Data
Sep. 2, 2019 (KR) 10-2019-0108488

(51) Int. Cl. G06K 9/62; H04W 4/40; H04W 4/33; H04W 4/024; G06K 9/00; G01C 21/20

(52) U.S. Cl. CPC G06K 9/6256; H04W 4/40; H04W 4/33; G06K 2209/21; G06K 9/00791; G01C 21/206; H04W 4/024

(57) ABSTRACT

Disclosed herein an artificial intelligence apparatus for providing location information of a vehicle including a memory configured to store an indoor map, a communicator configured to receive localization information of the vehicle, navigation information of the vehicle and image data obtained by capturing an image of a surrounding environment of the vehicle, a learning processor configured to provide the image data to an object analysis model to acquire object information in an image, and a processor configured to determine the location of the vehicle on the indoor map based on the localization information of the vehicle, the navigation information of the vehicle and the object information in the image.

### CROSS-REFERENCE TO RELATED APPLICATIONS

This application claims priority to Korean Patent Application No. 10-2019-0108488 filed on Sep. 2, 2019 in the Republic of Korea, the entire contents of which is hereby incorporated by reference in its entirety.

### BACKGROUND

The present disclosure relates to an artificial intelligence (AI) apparatus and method for providing location information of a vehicle, and more particularly, to an artificial intelligence apparatus and method capable of remotely determining the current location of a vehicle.

Artificial intelligence (AI) refers to one field of computer engineering and information technology of studying a method for making a computer think, learn, and do self-improvement, which is achieved based on human intelligence, and means that a computer emulates an intelligent behavior of the human.

AI is largely related directly and indirectly to other fields of a computer science rather than existing itself. In particular, AI elements have been modernly introduced in various fields of information technology, and there has been an active attempt to use AI to overcome problems of the fields.

Research has been actively conducted into technology of recognizing and learning a surrounding situation using AI and providing information desired by a user in the desired form or performing an operation or function desired by the user.

An electronic device for providing such various operations and functions is referred to as an AI device.

Meanwhile, in provision of a vehicle sharing service, it may be difficult for a user who wants to rent a vehicle to accurately determine the location of a vehicle. In addition, if an expensive vehicle is stolen, there is a need for accurately determining the location of the stolen vehicle.

A global positioning system (GPS) signal may be used to determine the location of the vehicle. However, when the vehicle is located indoors, it may be difficult to accurately determine the location of the vehicle.

Image data captured by a vehicle or a camera installed in the vehicle may be used to accurately determine the location of the vehicle.

### SUMMARY

An object of the present disclosure is to solve the above-described problems and the other problems.

Another object of the present disclosure is to provide an artificial intelligence apparatus and method for providing location information of a vehicle.

Another object of the present disclosure is to provide an artificial intelligence apparatus and method for determining the location of a vehicle based on localization information of a vehicle, navigation information of the vehicle and object information in an image of image data.

Another object of the present disclosure is to provide an artificial intelligence apparatus and method for verifying the access authority of an external device which has requested to share location information of a vehicle and transmitting, to the external device, a map, to which the location of the vehicle is mapped, and image data.

According to an embodiment, provided is an artificial intelligence apparatus for providing location information of a vehicle including a memory configured to store an indoor map, a communicator configured to receive localization information of the vehicle, navigation information of the vehicle and image data obtained by capturing an image of a surrounding environment of the vehicle, a learning processor configured to provide the image data to an object analysis model to acquire object information in an image, and a processor configured to determine the location of the vehicle on the indoor map based on the localization information of the vehicle, the navigation information of the vehicle and the object information in the image.

In the embodiment, the processor may be configured to receive a location information sharing request of the vehicle from an external device via the communicator, and transmit, to the external device, the indoor map, to which the determined location of the vehicle is mapped, and the image data the via communicator, if the external device has authority to access the location information of the vehicle.

According to an embodiment, provided is a method of providing location information of a vehicle at an artificial intelligence apparatus including storing an indoor map, receiving localization information of the vehicle, navigation information of the vehicle and image data obtained by capturing an image of a surrounding environment of the vehicle, providing the image data to an object analysis model to acquire object information in an image, and determining the location of the vehicle on the indoor map based on the localization information of the vehicle, the navigation information of the vehicle and the object information in the image.

In the embodiment, the method may further include receiving a location information sharing request of the vehicle from an external device, and transmitting, to the external device, the indoor map, to which the determined location of the vehicle is mapped, and the image data, if the external device has authority to access the location information of the vehicle.

### BRIEF DESCRIPTION OF THE DRAWINGS

The present disclosure will become more fully understood from the detailed description given herein below and the accompanying drawings, which are given by illustration only, and thus are not limitative of the present disclosure, and wherein:

FIG. 1 illustrates an AI device 100 according to an embodiment of the present disclosure;

FIG. 2 illustrates an AI server 200 according to an embodiment of the present disclosure;

FIG. 3 illustrates an AI system 1 according to an embodiment of the present disclosure;

FIG. 4 is a view illustrating an example of an AI system 1 according to an embodiment of the present disclosure;

FIG. 5 is a flowchart illustrating a method of providing location information of a vehicle at an AI apparatus according to an embodiment of the present disclosure;

FIG. 6 is a flowchart illustrating a method of determining the location of a vehicle using image data of a vehicle according to an embodiment of the present disclosure;

FIG. 7 is a view illustrating a process of outputting object information in an image from image data at an object analysis model according to an embodiment of the present disclosure;

FIG. 8 is a view illustrating a process of processing a location information sharing request of a vehicle from an external device at an AI apparatus according to an embodiment of the present disclosure;

FIG. 9 is a view illustrating a location information screen of a vehicle output to an external device when a vehicle is located outdoors according to an embodiment of the present disclosure; and

FIG. 10 is a view illustrating a location information screen of a vehicle output to an external device when a vehicle is located indoors according to an embodiment of the present disclosure.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

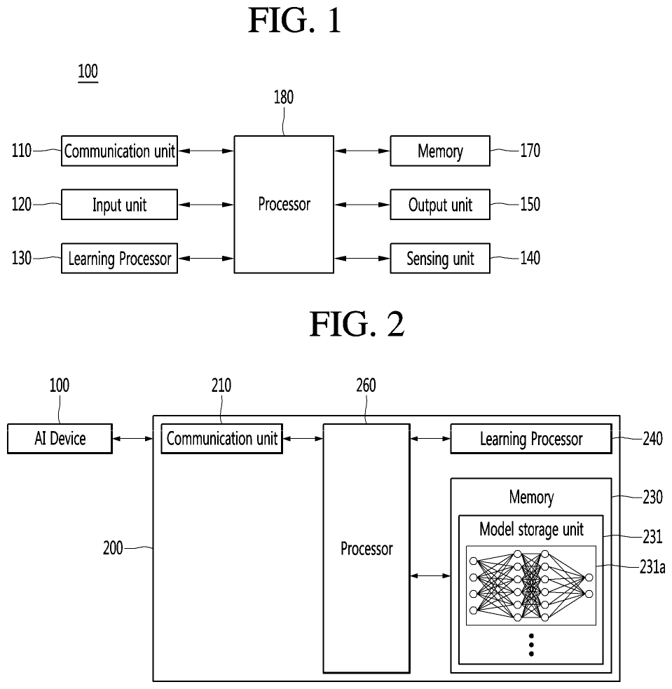

FIG. 1 illustrates an AI device 100 according to an embodiment of the present disclosure.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the Al device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the Al device 100. For example, the memory 170 may store input data acquired by the input unit 120, learning data, a learning model, a learning history, and the like.

The processor 180 may determine at least one executable operation of the Al device 100 based on information determined or generated by using a data analysis algorithm or a machine learning algorithm. The processor 180 may control the components of the Al device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the Al processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

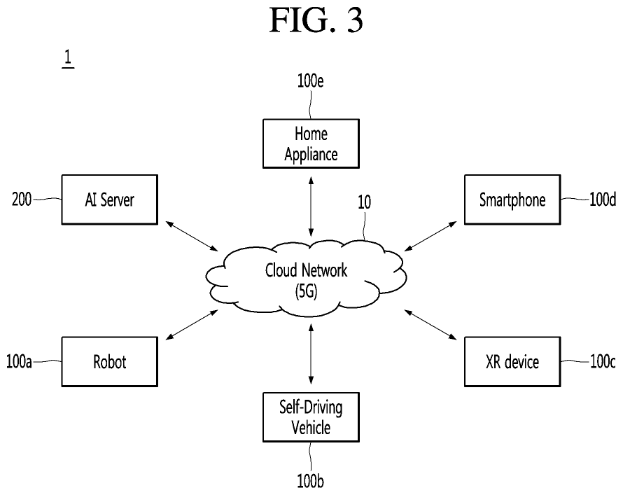

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

First, artificial intelligence (AI) will be described briefly.

Artificial intelligence (Al) is one field of computer engineering and information technology for studying a method of enabling a computer to perform thinking, learning, and self-development that can be performed by human intelligence and may denote that a computer imitates an intelligent action of a human.

Moreover, AI is directly/indirectly associated with the other field of computer engineering without being individually provided. Particularly, at present, in various fields of information technology, an attempt to introduce AI components and use the AI components in solving a problem of a corresponding field is being actively done.

Machine learning is one field of AI and is a research field which enables a computer to perform learning without an explicit program.

In detail, machine learning may be technology which studies and establishes a system for performing learning based on experiential data, performing prediction, and autonomously enhancing performance and algorithms relevant thereto. Algorithms of machine learning may use a method which establishes a specific model for obtaining prediction or decision on the basis of input data, rather than a method of executing program instructions which are strictly predefined.

The term “machine learning” may be referred to as “machine learning”.

In machine learning, a number of machine learning algorithms for classifying data have been developed. Decision tree, Bayesian network, support vector machine (SVM), and artificial neural network (ANN) are representative examples of the machine learning algorithms.

The decision tree is an analysis method of performing classification and prediction by schematizing a decision rule into a tree structure.

The Bayesian network is a model where a probabilistic relationship (conditional independence) between a plurality of variables is expressed as a graph structure. The Bayesian network is suitable for data mining based on unsupervised learning.

The SVM is a model of supervised learning for pattern recognition and data analysis and is mainly used for classification and regression.

The ANN is a model which implements the operation principle of biological neuron and a connection relationship between neurons and is an information processing system where a plurality of neurons called nodes or processing elements are connected to one another in the form of a layer structure.

The ANN is a model used for machine learning and is a statistical learning algorithm inspired from a neural network (for example, brains in a central nervous system of animals) of biology in machine learning and cognitive science.

In detail, the ANN may denote all models where an artificial neuron (a node) of a network which is formed through a connection of synapses varies a connection strength of synapses through learning, thereby obtaining an ability to solve problems.

The term “ANN” may be referred to as “neural network”.

The ANN may include a plurality of layers, and each of the plurality of layers may include a plurality of neurons. Also, the ANN may include a synapse connecting a neuron to another neuron.

The ANN may be generally defined by the following factors: (1) a connection pattern between neurons of a different layer; (2) a learning process of updating a weight of a connection; and (3) an activation function for generating an output value from a weighted sum of inputs received from a previous layer.

The ANN may include network models such as a deep neural network (DNN), a recurrent neural network (RNN), a bidirectional recurrent deep neural network (BRDNN), a multilayer perceptron (MLP), and a convolutional neural network (CNN), but is not limited thereto.

In this specification, the term “layer” may be referred to as “layer”.

The ANN may be categorized into single layer neural networks and multilayer neural networks, based on the number of layers.

General single layer neural networks is configured with an input layer and an output layer.

Moreover, general multilayer neural networks is configured with an input layer, at least one hidden layer, and an output layer.

The input layer is a layer which receives external data, and the number of neurons of the input layer is the same the number of input variables, and the hidden layer is located between the input layer and the output layer and receives a signal from the input layer to extract a characteristic from the received signal and may transfer the extracted characteristic to the output layer. The output layer receives a signal from the hidden layer and outputs an output value based on the received signal. An input signal between neurons may be multiplied by each connection strength (weight), and values obtained through the multiplication may be summated. When the sum is greater than a threshold value of a neuron, the neuron may be activated and may output an output value obtained through an activation function.

The DNN including a plurality of hidden layers between an input layer and an output layer may be a representative ANN which implements deep learning which is a kind of machine learning technology.

The term “deep learning” may be referred to as “deep learning”.

The ANN may be trained by using training data. Here, training may denote a process of determining a parameter of the ANN, for achieving purposes such as classifying, regressing, or clustering input data. A representative example of a parameter of the ANN may include a weight assigned to a synapse or a bias applied to a neuron.

An ANN trained based on training data may classify or cluster input data, based on a pattern of the input data.

In this specification, an ANN trained based on training data may be referred to as a trained model.

Next, a learning method of an ANN will be described.

The learning method of the ANN may be largely classified into supervised learning, unsupervised learning, semi-supervised learning, and reinforcement learning.

The supervised learning may be a method of machine learning for analogizing one function from training data.

Moreover, in analogized functions, a function of outputting continual values may be referred to as regression, and a function of predicting and outputting a class of an input vector may be referred to as classification.

In the supervised learning, an ANN may be trained in a state where a label of training data is assigned.

Here, the label may denote a right answer (or a result value) to be inferred by an ANN when training data is input to the ANN.

In this specification, a right answer (or a result value) to be inferred by an ANN when training data is input to the ANN may be referred to as a label or labeling data.

Moreover, in this specification, a process of assigning a label to training data for learning of an ANN may be referred to as a process which labels labeling data to training data.

In this case, training data and a label corresponding to the training data may configure one training set and may be inputted to an ANN in the form of training sets.

Training data may represent a plurality of features, and a label being labeled to training data may denote that the label is assigned to a feature represented by the training data. In this case, the training data may represent a feature of an input object as a vector type.

An ANN may analogize a function corresponding to an association relationship between training data and labeling data by using the training data and the labeling data. Also, a parameter of the ANN may be determined (optimized) through evaluating the analogized function.

The unsupervised learning is a kind of machine learning, and in this case, a label may not be assigned to training data.

In detail, the unsupervised learning may be a learning method of training an ANN so as to detect a pattern from training data itself and classify the training data, rather than to detect an association relationship between the training data and a label corresponding to the training data.

Examples of the unsupervised learning may include clustering and independent component analysis.

In this specification, the term “clustering” may be referred to as “clustering”.

Examples of an ANN using the unsupervised learning may include a generative adversarial network (GAN) and an autoencoder (AE).

The GAN is a method of improving performance through competition between two different AIs called a generator and a discriminator.

In this case, the generator is a model for creating new data and generates new data, based on original data.

Moreover, the discriminator is a model for recognizing a pattern of data and determines whether inputted data is original data or fake data generated from the generator.

Moreover, the generator may be trained by receiving and using data which does not deceive the discriminator, and the discriminator may be trained by receiving and using deceived data generated by the generator. Therefore, the generator may evolve so as to deceive the discriminator as much as possible, and the discriminator may evolve so as to distinguish original data from data generated by the generator.

The AE is a neural network for reproducing an input as an output.

The AE may include an input layer, at least one hidden layer, and an output layer.

In this case, the number of node of the hidden layer may be smaller than the number of nodes of the input layer, and thus, a dimension of data may be reduced, whereby compression or encoding may be performed.

Moreover, data outputted from the hidden layer may enter the output layer. In this case, the number of nodes of the output layer may be larger than the number of nodes of the hidden layer, and thus, a dimension of the data may increase, and thus, decompression or decoding may be performed.

The AE may control the connection strength of a neuron through learning, and thus, input data may be expressed as hidden layer data. In the hidden layer, information may be expressed by using a smaller number of neurons than those of the input layer, and input data being reproduced as an output may denote that the hidden layer detects and expresses a hidden pattern from the input data.

The semi-supervised learning is a kind of machine learning and may denote a learning method which uses both training data with a label assigned thereto and training data with no label assigned thereto.

As a type of semi-supervised learning technique, there is a technique which infers a label of training data with no label assigned thereto and performs learning by using the inferred label, and such a technique may be usefully used for a case where the cost expended in labeling is large.

The reinforcement learning may be a theory where, when an environment where an agent is capable of determining an action to take at every moment is provided, the best way is obtained through experience without data.

The reinforcement learning may be performed by a Markov decision process (MDP).

To describe the MDP, firstly an environment where pieces of information needed for taking a next action of an agent may be provided, secondly an action which is to be taken by the agent in the environment may be defined, thirdly a reward provided based on a good action of the agent and a penalty provided based on a poor action of the agent may be defined, and fourthly an optimal policy may be derived through experience which is repeated until a future reward reaches a highest score.

An artificial neural network has a configuration that is specified by a configuration of a model, an activation function, a loss function or a cost function, a learning algorithm, an optimization algorithm, or the like, a hyperparaineter may be preset before learning, and then, a model parameter may be set through learning to specify information.

For example, a factor for determining a configuration of the artificial neural network may include the number of hidden layers, the number of hidden nodes included in each hidden layer, an input feature vector, a target feature vector, or the like.

The hyperparameter may include various parameters that need to be initially set for learning, such as an initial value of the model parameter. The model parameter may include various parameters to be determined through learning.

For example, the hyperparameter may include a weight initial value between nodes, a bias initial value between nodes, a size of mini-batch, a number of repetitions of learning, a learning rate, or the like. The model parameter may include a weight between nodes, bias between nodes, or the like.

The loss function can be used for an index (reference) for determining optimum model parameters in a training process of an artificial neural network. In an artificial neural network, training means a process of adjusting model parameters to reduce the loss function and the object of training can be considered as determining model parameters that minimize the loss function.

The loss function may mainly use mean square error (MSE) or cross entropy error (CEE), but the present disclosure is not limited thereto.

The CEE may be used when a correct answer label is one-hot encoded. One-hot encoding is an encoding method for setting a correct answer label value to 1 for only neurons corresponding to a correct answer and setting a correct answer label to 0 for neurons corresponding to a wrong answer.

A learning optimization algorithm may be used to minimize a loss function in machine learning or deep learning, as the learning optimization algorithm, there are Gradient Descent (GD), Stochastic Gradient Descent (SGD), Momentum, NAG (Nesterov Accelerate Gradient), Adagrad, AdaDelta, RMSProp, Adam, and Nadam.

The GD is a technique that adjusts model parameters such that a loss function value decreases in consideration of the gradient of a loss function in the current state.

The direction of adjusting model parameters is referred to as a step direction and the size of adjustment is referred to as a step size.

In this case, the step size may refer to a learning rate.

The GD may partially differentiate the loss function with each of model parameters to acquire gradients and may change and update the model parameters by the learning rate in the acquired gradient direction.

The SGD is a technique that increases the frequency of gradient descent by dividing training data into mini-batches and performing the GD for each of the mini-batches.

The Adagrad, AdaDelta, and RMSProp in the SGD are techniques that increase optimization accuracy by adjusting the step size. The momentum and the NAG in the SGD are techniques that increase optimization accuracy by adjusting the step direction. The Adam is a technique that increases optimization accuracy by adjusting the step size and the step direction by combining the momentum and the RMSProp. The Nadam is a technique that increases optimization accuracy by adjusting the step size and the step direction by combining the NAG and the RMSProp.

The learning speed and accuracy of an artificial neural network greatly depends on not only the structure of the artificial neural network and the kind of a learning optimization algorithm, but the hyperparameters. Accordingly, in order to acquire a good trained model, it is important not only to determine a suitable structure of an artificial neural network, but also to set suitable hyperparameters.

In general, hyperparameters are experimentally set to various values to train an artificial neural network, and are set to optimum values that provide stable learning speed and accuracy using training results.

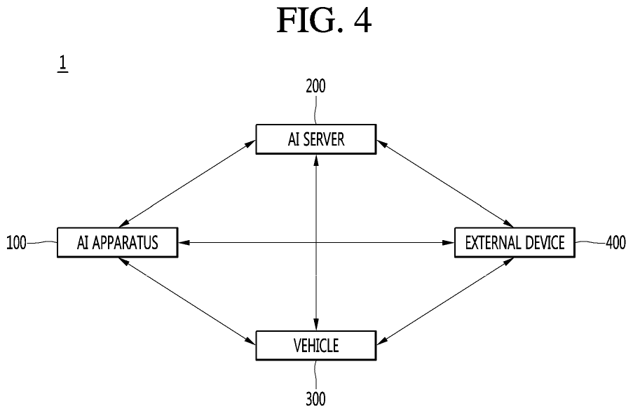

FIG. 4 is a view illustrating an example of an AI system 1 according to an embodiment of the present disclosure.

Referring to FIG. 4, the AI system I may include an AI apparatus 100, an AI server 200, a vehicle 300 and an external device 400.

The AI apparatus 100, the AI server 200, the vehicle 300 and the external device 400 may communicate with each other using wired/wireless communication technology.

In particular, the AI apparatus 100, the AI server 200, the vehicle 300 and the external device 400 may communicate with each other using 5G network technology.

In addition, the AI apparatus 100 may acquire the identification information of the vehicle 300 and the external device 400. The AI apparatus 100 may identify the vehicle 300 and the external device 400. The AI apparatus 100 may identify the vehicle 300 and the external device 400, which have transmitted data, when data is received from the vehicle 300 and the external device 400.

The vehicle 300 includes a vehicle equipped with a black box or a vehicle equipped with a camera.

In addition, the vehicle 300 may transmit and receive data to and from external devices using wired/wireless communication technology. The vehicle 300 may acquire GPS based information via a communication unit. In addition, the vehicle 300 may acquire triangulation location information based on a 5G network via the communication unit. The triangulation method refers to a method of calculating the location of a vehicle based on the coordinates of at least three base stations and a distance from a vehicle. In order to measure the distances between the vehicle and the base stations, the strength of a signal may be converted into distance information or a signal transmission time, a signal transmission time difference, a signal transmission angle or the like may be used.

The location information may be obtained by measuring the location of a vehicle based on communication information between the vehicle and at least three base stations using a 5G network.

In addition, the location information may include at least one of GPS location information acquired by the vehicle or triangulation location information.

The external device 400 may include a mobile phone, a smartphone, a computer, a tablet, a smart watch, or the like.

For example, the external device 400 may receive the location information of the vehicle 300, a map and image data obtained by capturing the image the surrounding environment of the vehicle 300 from the AI apparatus 100 via the communication unit, and output visual information via a display.

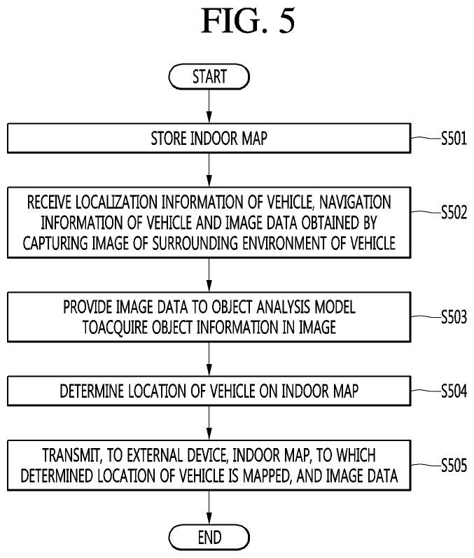

FIG. 5 is a flowchart illustrating a method of providing location information of a vehicle at an AI apparatus according to an embodiment of the present disclosure.

The memory 170 may store an indoor map (S501).

The indoor map is a map of an indoor space and may include an indoor map of each floor if a building includes a plurality of floors. In addition, the indoor map may be created in the form of a drawing based on the design drawing of each building.

The memory 170 may store the indoor map including information on an object capable of identifying a predetermined location indoors.

In addition, the indoor map may include information on an object capable of identifying a predetermined location indoors. For example, the indoor map may include information on an object such as a sign capable of identifying each floor of an underground parking lot. In addition, the indoor map may include information on a character or numerical object capable of identifying a parking area. In addition, the indoor map may include information on an indoor structure of a building.

The memory 170 may store an outdoor map.

The outdoor map may include information on a location or shape of a road, a location of a building, traffic conditions, traffic information or the like.

The memory 170 may store information on at least one device authorized to access the location information of a vehicle.

For example, the processor 180 may receive the information on at least one device authorized to access the location information of the vehicle 300 from the vehicle 300 via the communication unit 110 and store the received information on the at least one device in the memory 170. Accordingly, the vehicle 300 may register at least one external device 400 having authority to access the location information of the vehicle 300.

The communication unit 110 may receive the localization information of the vehicle 300, the navigation information of the vehicle 300 and image data of the surrounding environment of the vehicle 300 (S502).

The localization information of the vehicle 300 may include at least one of GPS location information or triangulation location information of the vehicle 300. For example, when the vehicle 300 is located outdoors, the vehicle 300 may acquire GPS location information based on the GPS and acquire triangulation location information based on a 5G network. In contrast, when the vehicle 300 is located indoors, the vehicle 300 may fail to acquire the GPS location information based on the GPS. In this case, the vehicle 300 may acquire the triangulation location information based on the 5G network, and the localization information of the vehicle 300 may include only the triangulation location information.

The navigation information of the vehicle 300 may include information at least one of a starting point, a destination, a traveling path or a traveling time of the vehicle 300. The navigation information of the vehicle 300 may be generated by a vehicle driving guidance terminal mounted in the vehicle.

The communication unit 110 may receive the image data obtained by capturing the image of the surrounding environment of the vehicle 300.

The vehicle 300 may acquire the image data obtained by capturing the surrounding environment of the vehicle 300 via a camera. For example, the image data may be obtained by capturing the front and rear sides of the vehicle by the black box mounted in the vehicle 300. The vehicle 300 may store the acquired image data and transmit the stored image data to the AI apparatus 100.

The learning processor 130 may provide the image data to an object analysis model to acquire object information in the image (S503).

The object analysis model may be a neural network trained to extract object information including location identification information for identifying the location of the vehicle from the image.

Referring to FIG. 7, the learning processor 130 may provide image data 701 to object analysis model 702 to acquire one or more pieces of object information 703, 704 and 705. For example, the learning processor 130 may provide the image data 701 to the object analysis model 702 to acquire the object information in the image, such as a first parking area identification sign “B2 6” 703, a second parking area identification sign “B2 7” 704 and a parked neighboring vehicle “sedan 65LAOOOO” 705.

In addition, the learning processor 130 may provide the image data to the object analysis model to acquire the object information in the image including location identification information for identifying the location of the vehicle.

The location identification information for identifying the location of the vehicle is necessary to determine the location of the vehicle and may be acquired from the image data. For example, the location identification information for identifying the location of the vehicle may include the location identification characters or numbers of an underground parking lot, the type of a parked neighboring vehicle, and a license plate number.

The processor 180 may determine the location of the vehicle on the indoor map based on the localization information of the vehicle, the navigation information of the vehicle and the object information in the image (S504).

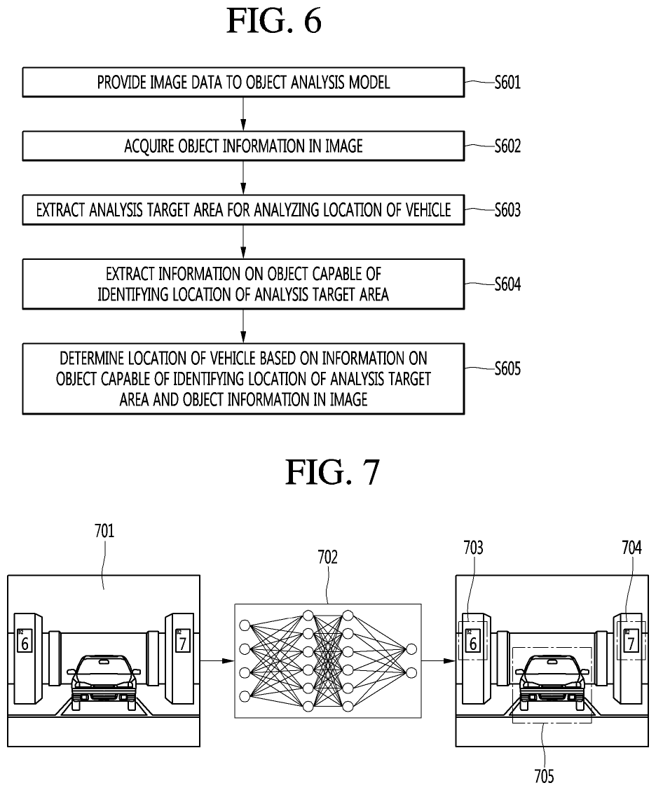

Referring to FIG. 6, the learning processor 130 may provide the image data to the object analysis model (S601).

In addition, the learning processor 130 may acquire the object information in the image (S602).

In addition, the processor 180 may extract an analysis target area for analyzing the location of the vehicle based on at least one of the localization information of the vehicle and the navigation information of the vehicle (S603).

The processor 180 may acquire the location information of the vehicle including latitude and longitude based on the localization information of the vehicle and extract the analysis target area for analyzing the location of the vehicle based on the acquired location information. In this case, the localization information of the vehicle may include at least one of GPS location information or triangulation location information.

For example, the processor 180 may acquire the location information of the vehicle including latitude “37.392881” and longitude “127.112135” based on the localization information of the vehicle. In addition, the processor 180 may determine that an “ABC department store” is located at the acquired latitude and longitude and extract an area where the “ABC department store” is located as the analysis target area for analyzing the location of the vehicle. Accordingly, the processor 180 may extract the analysis target area for analyzing the location of the vehicle based on the triangulation location information, even if the vehicle is parked in the underground parking lot of the “ABC department store” and thus it is difficult to acquire the GPS location information of the vehicle.

The processor 180 may acquire information on a destination of the vehicle based on the navigation information of the vehicle and extract the analysis target area for analyzing the location of the vehicle based on the acquired destination.

For example, when the destination of the vehicle is an “ABC department store”, the processor 180 may extract the area where “the ABC department store” is located as the analysis target area for analyzing the location of the vehicle. Accordingly, the processor 180 may extract the analysis target area for analyzing the location of the vehicle based on the triangulation location information, even if the vehicle is parked in the underground parking lot of the “ABC department store” and thus it is difficult to acquire the GPS location information of the vehicle.

In addition, the processor 180 may extract information on the object capable of identifying the location of the analysis target area from the indoor map (S604)

The processor 180 may extract an indoor map of each floor of the analysis target area, parking area information of each floor of a parking lot, sign information capable of identifying each floor of the parking lot, and information on a character or numerical object capable of identifying a parking area from the indoor map.

For example, when the analysis target area is an area where “the ABC department store”, the processor 180 may extract an indoor map of each floor of “the ABC department store”, parking area information of each floor of an underground parking lot, sign information capable of identifying each floor of the parking lot, and information on a character or numerical object capable of identifying a parking area from the indoor map.

In addition, the processor 180 may determine the location of the vehicle based on information capable of identifying the location of the analysis target area and the object information in the image (S605).

The processor 180 may determine the location of the vehicle, by comparing the object information in the image acquired from the image data of the vehicle with the information capable of identifying the location of the analysis target area.

For example, when the object information in the image is “B2 6” and the information capable of identifying the location of the analysis target area “the ABC department store” is second basement parking area identification information “B2 6”, the processor 180 may determine that the vehicle is located in area 6 of the second basement level of “the ABC department store”.

The processor 180 may transmit, to the external device 400, the indoor map, to which the determined location of the vehicle is mapped, and the image data (S505).

The processor 180 may receive a location information sharing request of the vehicle 300 from the external device 400 via the communication unit 110, and transmit, to the external device 400, the indoor map, to which the determined location of the vehicle 300 is mapped, and the image data via the communication unit 110, when the external device 400 has authority to access the location information of the vehicle 300.

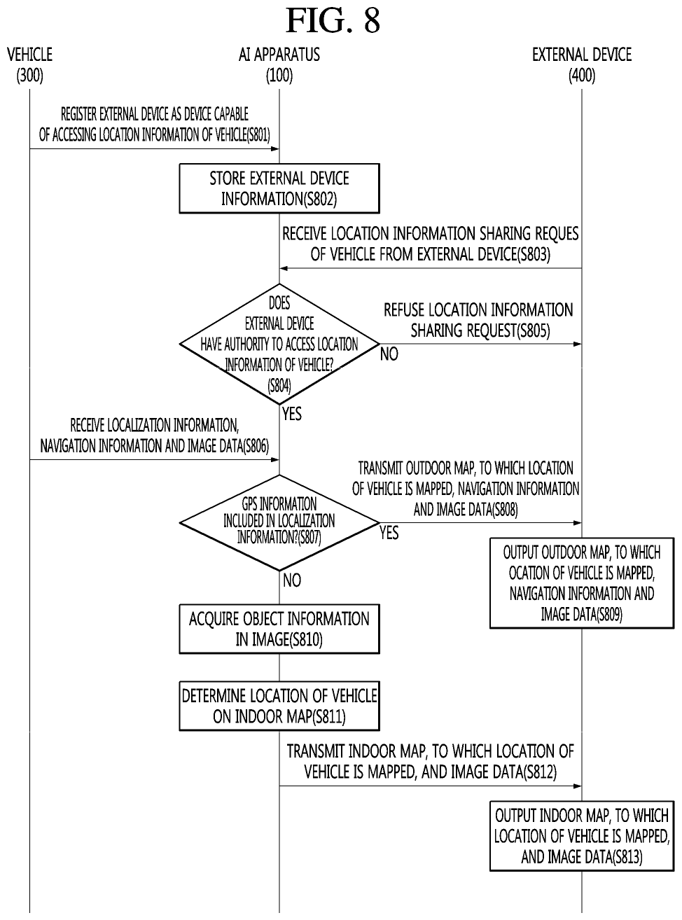

FIG. 8 is a view illustrating a process of processing a location information sharing request of a vehicle from an external device at an AI apparatus according to an embodiment of the present disclosure.

The vehicle 300 may register at least one external device 400 in the AI apparatus 100 as a device capable of accessing the location information of the vehicle 300 (S801).

The AI apparatus 100 may store the device information of the external device 400 received from the vehicle 300 in the memory 170 (S802). In addition, the AI apparatus 100 may store the device information of the device, which needs to access the location information of the vehicle 300 in an emergency situation, in the memory 170.

The AI apparatus 100 may receive the location information sharing request of the vehicle 300 from the external device 400 (S803).

The AI apparatus 100 may determine whether the external device 400 has authority to access the location information of the vehicle 300 (S804).

The AI apparatus 100 may refuse the location information sharing request when the external device 400 does not have authority to access the location information of the vehicle 300 (S805).

The AI apparatus 100 may receive the localization information of the vehicle 300, the navigation information of the vehicle 300 and the image data obtained by capturing the image of the surrounding environment of the vehicle 300 (S806).

The AI apparatus 100 may determine whether GPS information is included in the received localization information (S807). When the vehicle 300 is located outdoors, the GPS information may be included in the localization information.

The AI apparatus 100 may transmit an outdoor map, to which the location of the vehicle 300 is mapped, the navigation information of the vehicle 300 and the immze data to the external device 400, when the GPS information is included in the received localization information (S808).

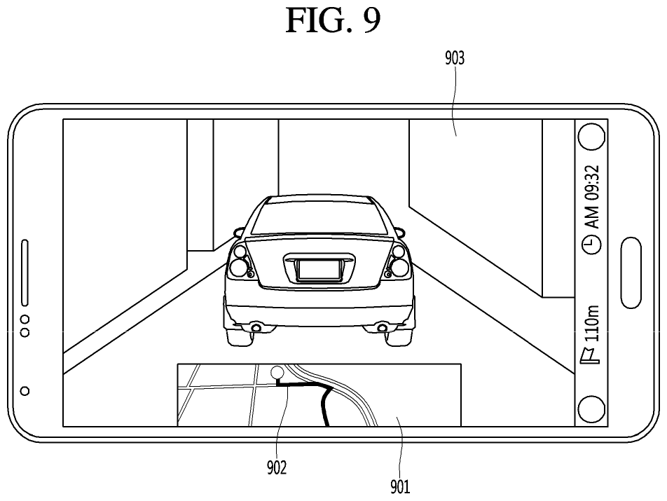

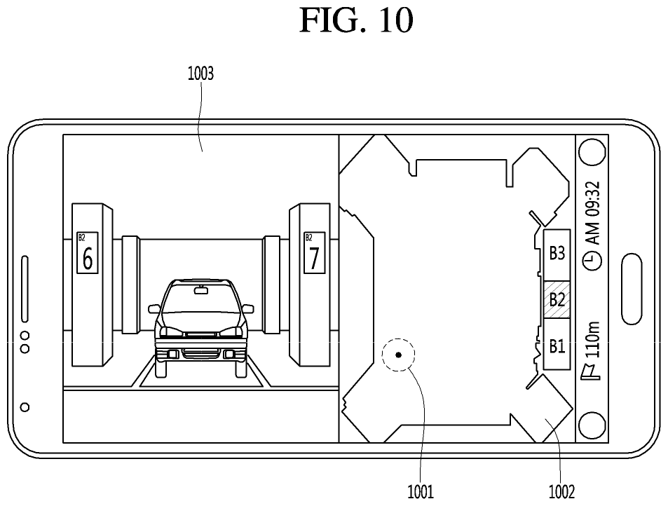

For example, the processor 180 may receive the location information sharing request of the vehicle 300 from the external device 400 via the communication unit 110, and transmit the outdoor map, to which the location of the vehicle 300 is mapped, the navigation information of the vehicle 300 and the image data to the external device 400 via the communication unit 110 when the external device 400 has authority to access the location information of the vehicle 300 and the GPS information is included in the localization information of the vehicle 300. In this case, the external device 400 may output the outdoor map, to which the location of the vehicle 300 is mapped, the navigation information of the vehicle 300 and the image data (S809). Referring to FIG. 9, the external device 400 may output the outdoor map, to which the location 901 of the vehicle is mapped, navigation information 902 including the traveling path and destination of the vehicle, and image data 903.

Meanwhile, when the vehicle 300 is located indoors and GPS information is not included in the localization information, the triangulation location information of the vehicle may be included in the localization information.

The AI apparatus 100 may provide the image data to the object analysis data to acquire the object information in the image in order to accurately determine the location of the vehicle 300 located indoors (S810).

In addition, the AI apparatus 100 may determine the location of the vehicle on the indoor map based on the localization information of the vehicle, the navigation information of the vehicle and the object information in the image (S811).

The AI apparatus 100 may transmit the indoor map, to which the location of the vehicle is mapped, and the image data to the external device 400 having authority to access the location information of the vehicle 300 (S812).

In this case, the external device 400 may output the indoor map, to which the location of the vehicle is mapped, and the image data.

Referring to FIG. 10, the external device 400 may output the indoor map 1001, to which the location 1001 of the vehicle is mapped, and the image data 1003.

According to the embodiment of the present disclosure, in provision of a vehicle sharing service, a user who wants to rent a vehicle can accurately determine the location of a vehicle.

According to the embodiment of the present disclosure, if a vehicle is stolen, the AI apparatus can provide a user with the current location of the vehicle, thereby rapidly and accurately determining the location of the vehicle.

According to the embodiment of the present disclosure, when a vehicle is located indoors, the AI apparatus can provide the user with an indoor map, to which the location of the vehicle is mapped, and image data of the user, thereby accurately determining the location of the vehicle.

The present disclosure described above may be embodied as computer readable codes on a medium in which a program is recorded. The computer-readable medium includes all kinds of recording devices in which data readable by a computer system is stored. Examples of the computer readable medium may include a hard disk drive (HDD), a solid state disk (SSD), a silicon disk drive (SDD), a ROM, a RAM, a CD-ROM, a magnetic tape, a floppy disk, an optical data storage device, and the like. In addition, the computer may include the processor 180 of the terminal.

What is claimed is:

1. An artificial intelligence apparatus for providing location information of a vehicle, the artificial intelligence apparatus comprising:
a memory configured to store an indoor map of an indoor space;
a communicator configured to receive localization information of the vehicle, navigation information of the vehicle, and image data obtained by capturing an image of a surrounding environment of the vehicle;
a learning processor configured to provide the image data to an object analysis model to acquire object information about an object included in the image; and
a processor configured to determine a location of the vehicle on the indoor map based on the localization information of the vehicle, the navigation information of the vehicle, and the object information about the object included in the image.

2. The artificial intelligence apparatus of claim 1, wherein the processor is further configured to:
receive a location information sharing request requesting the location of the vehicle from an external device via the communicator, and in response to the external device having authority to access the location of the vehicle, transmit, to the external device, the indoor map and the image data via the communicator, wherein the indoor map includes indoor location information identifying a location of the vehicle on the indoor map.

3. The artificial intelligence apparatus of claim 1, wherein the object information includes location identification information for identifying the location of the vehicle within the indoor space.

4. The artificial intelligence apparatus of claim 1, wherein the memory is further configured to store an indoor map of an indoor space and information on an indoor object capable of identifying a predetermined location within the indoor space.

5. The artificial intelligence apparatus of claim 1, wherein the processor is further configured to:
extract an analysis target area for analyzing the location of the vehicle based on at least one of the localization information of the vehicle or the navigation information of the vehicle,
extract information on the object for identifying a location of the analysis target area from the indoor map, and
determine the location of the vehicle based on the information on the object for identifying the location of the analysis target area and the object information about the object included in the image.

6. The artificial intelligence apparatus of claim 1, wherein the processor is further configured to:
receive, from the vehicle, authorization information on at least one device authorized to access the location of the vehicle via the communicator, and
store the authorization information on the at least one device in the memory.

7. The artificial intelligence apparatus of claim 1, wherein the navigation information includes information on at least one of a starting point, a destination, a traveling path or a traveling time of the vehicle.

8. The artificial intelligence apparatus of claim 1, wherein the localization information is obtained based on communication information between the vehicle and at least three base stations using a 5G network.

9. The artificial intelligence apparatus of claim 1, wherein the memory is further configured to store an outdoor map,
wherein the processor is further configured to:
receive a location information sharing request requesting the location of the vehicle from an external device via the communicator, and
in response to the external device having authority to access the location of the vehicle and global positioning system (GPS) information being included in the localization information of the vehicle, transmit, to the external device, the outdoor map, the navigation information of the vehicle and the image data via the communicator, and
wherein the outdoor map includes outdoor location information identifying a location of the vehicle on the outdoor map.

10. A method of providing location information of a vehicle at an artificial intelligence apparatus, the method comprising:
storing, in a memory of the artificial intelligence apparatus, an indoor map of an indoor space;
receiving, by a receiver of the artificial intelligence apparatus, localization information of the vehicle, navigation information of the vehicle, and image data obtained by capturing an image of a surrounding environment of the vehicle;
providing, by at least one processor of the artificial intelligence apparatus, the image data to an object analysis model to acquire object information about an object included in the image; and
determining, by the at least one processor, a location of the vehicle on the indoor map based on the localization information of the vehicle, the navigation information of the vehicle, and the object information about the object included in the image.

11. The method of claim 10, further comprising:
receiving a location information sharing request requesting the location of the vehicle from an external device; and
in response to the external device having authority to access the location of the vehicle, transmitting, to the external device, the indoor map and the image data,
wherein the indoor map include indoor location information identifying a location of the vehicle on the indoor map.

12. The method of claim 10, wherein the object information includes location identification information for identifying the location of the vehicle within the indoor space.

13. The method of claim 10, further comprising:
storing, in the memory, an indoor map of an indoor space and information on an indoor object capable of identifying a predetermined location within the indoor space.

14. The method of claim 10, wherein the determining of the location of the vehicle on the indoor map includes:
extracting an analysis target area for analyzing the location of the vehicle based on at least one of the localization information of the vehicle or the navigation information of the vehicle;
extracting information on the object for identifying a location of the analysis target area from the indoor map; and
determining the location of the vehicle based on the information on the object for identifying the location of the analysis target area and the object information about the object included in the image.

15. The method of claim 10, further comprising:
receiving, from the vehicle, authorization information on at least one device authorized to access the location of the vehicle; and
storing the authorization information on the at least one device.

16. The method of claim 10, wherein the navigation information includes information on at least one of a starting point, a destination, a traveling path or a traveling time of the vehicle.

17. The method of claim 10, wherein the localization information is obtained based on communication information between the vehicle and at least three base stations using a 5G network.

18. The method of claim 10, further comprising:
storing an outdoor map in the memory;
receiving a location information sharing request requesting the location of the vehicle from an external device; and
in response to the external device having authority to access the location of the vehicle and global positioning system (GPS) information being included in the localization information of the vehicle, transmitting, to the external device, the outdoor map, the navigation information of the vehicle and the image data.

19. A device for providing location information of a vehicle based on artificial intelligence, the device comprising:
a memory configured to store a map;
a communication interface configured to receive localization information of the vehicle, navigation information of the vehicle, and image data obtained by capturing an image of a surrounding environment of the vehicle; and
at least one controller configured to:
perform object analysis on the image data based on at least one learning model to generate object information about an object included in the image of the surrounding environment of the vehicle,
determine a location of the vehicle on the map based on the localization information of the vehicle, the navigation information of the vehicle, and the object information about the object included in the image,
receive a location information sharing request requesting the location of the vehicle from an external device via the communication interface, and
in response to the external device having authority to access the location of the vehicle, transmit, to the external device, the map and the image data or the map and an image of the vehicle, via the communication interface.

20. The device of claim 19, wherein the object information includes location identification information for identifying the location of the vehicle within an indoor space, and
wherein the map includes direction information for guiding a user of external device to an indoor location within the indoor space corresponding to the location of the vehicle.
